(19) United States
(12) Patent Application Publication
(10) Pub. No.: US 2015/0060708 A1
(43) Pub. Date: Mar. 5, 2015

(54) BELLOWS VALVE WITH VALVE BODY CYLINDER ADAPTER

(71) Applicant: Swagelok Company, Solon, OH (US)

(72) Inventor: William H. Glime, III, Chagrin Falls, OH (US)

(21) Appl. No.: 14/472,655

(22) Filed: Aug. 29, 2014

Related U.S. Application Data
(60) Provisional application No. 61/872,077, filed on Aug. 30, 2013.

(51) Int. Cl. F16K 41/10; F16K 31/122; F16K 31/06; F16K 1/34

(52) U.S. Cl. CPC F16K 41/10; F16K 1/34; F16K 31/1225; F16K 31/1221; F16K 31/06
USPC 251/62; 251/335.1; 251/335.3; 251/129.01

(57) ABSTRACT

A valve having a valve body with a valve cavity that receives an axially extensible member, for example, a bellows. An adapter has a diameter that is less than the diameter of the valve cavity and greater than the diameter of the extensible member, so that the adapter is disposed between the valve body and the extensible member. The adapter forms a valve body compression seal and a compression seal for the extensible member. Use of the adapter allows a common valve body to be used with different sized bellows of different lengths and diameters as needed, as well as facilitates easy installation and replacement of the bellows.

### RELATED APPLICATION

This application claims the benefit of pending U.S. Provisional Application Ser. No. 61/872,077, which was filed on Aug. 30, 2013, for BELLOWS VALVE WITH VALVE BODY CYLINDER ADAPTER, the entire disclosure of which is fully incorporated herein by reference.

### BACKGROUND OF THE DISCLOSURE

The inventions relate to flow valves. The inventions more particularly relate to valves that utilize sealed subassemblies, for example a bellows.

### SUMMARY OF THE DISCLOSURE

A first inventive concept presented herein provides a valve design that facilitates machining one or more flow passageways in a valve body. In an embodiment, a valve cavity at least partially receives a valve member subassembly and an adapter. Additional embodiments are presented herein.

These and other inventive concepts and embodiments are fully described hereinbelow, and will be readily understood by those skilled in the art from the following detailed description of the exemplary embodiments in view of the accompanying drawings.

### BRIEF DESCRIPTION OF THE DRAWINGS

FIG. 1 illustrates an isometric view of an embodiment of a valve in accordance with the teachings herein, in combination with a pneumatic actuator.

FIG. 2 is the embodiment of FIG. 1 in longitudinal cross-section.

FIG. 3 is the embodiment of FIGS. 1 and 2 in exploded isometric.

FIG. 4 illustrates an isometric view of another embodiment of a valve in accordance with the teachings herein.

FIG. 5 is the embodiment of FIG. 4 in longitudinal cross-section with the valve in a closed position.

FIG. 6 is the embodiment of FIG. 4 in longitudinal cross-section with the valve in an open position.

FIG. 7 is the embodiment of FIGS. 4-6 in exploded isometric.

### DESCRIPTION OF THE EXEMPLARY EMBODIMENTS

The exemplary embodiments described herein are directed to a bellows valve, and to a bellows valve in combination with an actuator assembly, however, many different designs and configurations for the bellows valve and/or the actuator may be used as needed for particular applications. Use of the terms axial and radial are referenced to a longitudinal axis, such as for example, a central longitudinal axis X as noted on the drawings. In the exemplary drawings, the longitudinal axis X may be the central longitudinal axis of the valve body wherein a valve member or bellows or both are coaxial with the axis X.

A first inventive concept presented herein provides a valve design that facilitates machining one or more flow passageways in a valve body. In an embodiment, a valve body is formed with a valve cavity that is dimensioned so that angled ports and flow passageways can be machined with reduced difficulty. These dimensions may include diameter and axial length. For example, a larger inside diameter or alternatively a shorter valve body wall, or both, may be used that otherwise could not be realized without the inventive teachings herein. This allows larger flow passageways to be machined at shallower angles thereby providing greater flow through the valve compared to conventional valve bodies that result in steeper angles and smaller flow passageways.

In a further embodiment, the valve cavity at least partially receives a valve member subassembly and an adapter. The adapter may have a generally cylinder shape and is received in a generally cylinder shaped portion of the valve cavity. The adapter provides a seal with the valve member subassembly and a seal with the valve body to provide a sealed fluid flow cavity. Additional embodiments of this concept are presented herein.

In addition, use of an adapter as taught herein facilitates the ability to use a common or single valve body design with different bellows, for example, bellows having different dimensions (diameter or longitudinal length for example.)

Another inventive concept presented herein provides a valve design that facilitates machining one or more flow passageways in a valve body. In an embodiment, the valve body has a valve cavity that at least partially receives a valve member subassembly and an adapter. The adapter permits the valve body to be made shorter along a longitudinal axis compared to a valve body without an adapter so that the valve body can be more easily machined with flow passageways. The adapter provides a seal with the valve member subassembly and a seal with the valve body to provide a sealed fluid flow cavity. Additional embodiments of this concept are presented herein.

Another inventive concept presented herein provides a valve design that facilitates machining one or more flow passageways in a valve body. In an embodiment, the valve body has a valve cavity that at least partially receives a valve member subassembly and an adapter. The adapter permits the valve body to be made with a larger internal diameter compared to a valve body without a adapter so that the valve body can be more easily machined with flow passageways. The adapter provides a seal with the valve member subassembly and a seal with the valve body to provide a sealed fluid flow cavity. Additional embodiments of this concept are presented herein.

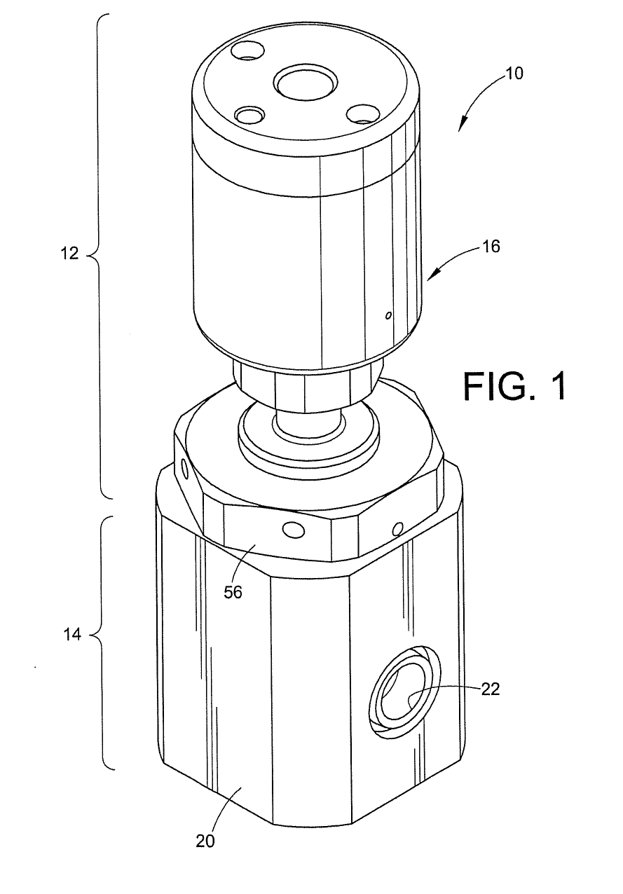

With reference to FIGS. 1-3, we illustrate an embodiment of an actuator and valve assembly 10. The actuator and valve assembly 10 may include a pneumatic actuator 12 that optionally may be axially stacked on top of a valve 14. The actuator 12 may include, for example, a pneumatically operated actuator assembly 16. Alternatively, the actuator 12 may be a manual actuator, for example with a handle or lever, or an electromagnetic actuator or a hydraulic actuator or any other type of actuator that produces a linear motion to open and close the valve 14.

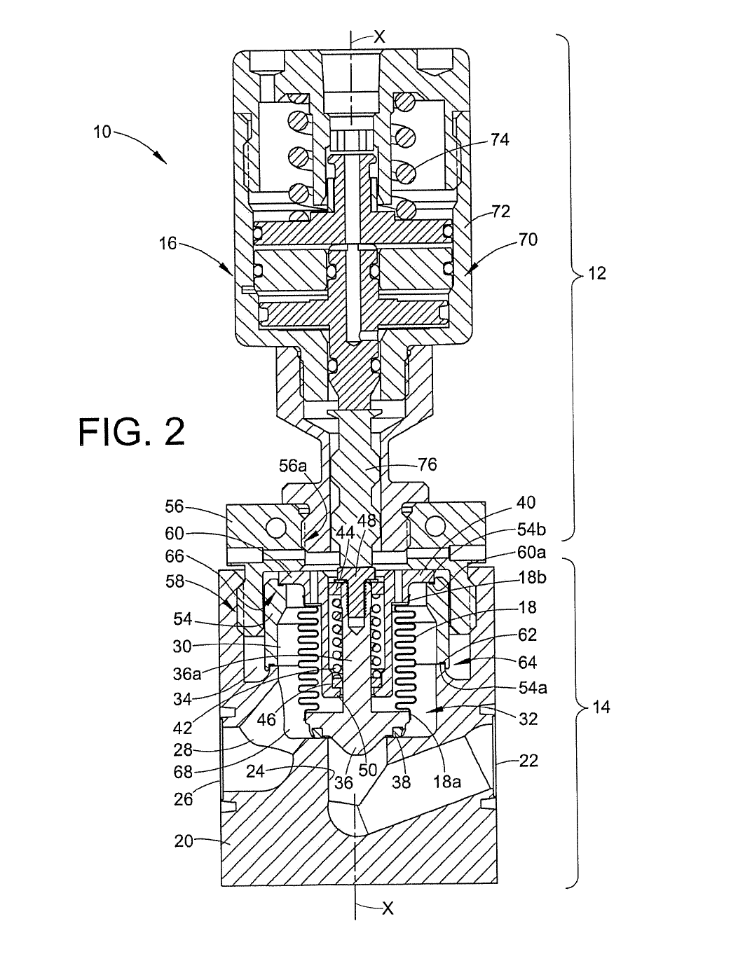

The valve 14 may have many different configurations and uses. For the exemplary embodiment illustrated herein, the valve 14 may be realized in the form of a valve that uses a hollow extensible member 18 (FIG. 2), for example a bellows, that extends and contracts axially to move a valve closure element (36) to open and close the valve 14 in response to operation of the actuator 12. Although the exemplary embodiments herein are described in the context of a bellows valve, we intend the terms “hollow extensible member” and “bellows” to be construed broadly, and to include a conventional or traditional bellows design or alternative bellows designs, for example a series of conical elements or springs or other elements that form a hollow extensible member. Bellows valves find particular use for high purity, high flow rate applications, but the inventions may be used in valves for many other types of applications.

An embodiment of a bellows valve in accordance with the teachings herein includes a valve body 20 that has two or more flow passageways therein so as to control the flow of fluid, for example a liquid or gas, from one port to another. For example, in a two port embodiment, a first or inlet flow port 22 (which is hidden in the orientation of FIG. 1) opens to a first or inlet flow passageway 24. A second or outlet flow port 26 opens to a second or outlet flow passageway 28. A sealed fluid flow cavity 30 opens to the outlet flow passageway 28 when the valve 14 is in an open position (note that FIG. 2 shows a valve closed position). The inlet flow passageway 24 opens to the sealed fluid flow cavity 30. The designations of inlet and outlet are arbitrary, it being understood that flow can be reversed through the valve 14 if so desired, and flow can be directed to other ports in a multi-port embodiment (not shown) if so need. The fluid flow cavity 30 is sealed in the sense that fluid is contained when the valve 14 is closed and fluid flows between the first flow passageway 24 and the second flow passageway 28 when the valve 14 is open.

A valve member subassembly 32 is at least partially disposed in a valve cavity 34 that optionally may be formed in a generally cylindrical shape in the valve body 20. The valve member subassembly 32 may include a valve closure element 36, for example, a valve stem. The valve stem 36 optionally carries or supports a valve seat 38. Alternatively, the valve seat 38 may be disposed in a groove in the valve body 20. The valve closure element 36 preferably is sealingly attached to a first end 18a of the bellows 18. For example, the valve closure element 36 may be welded to the bellows 18 generally at the location 18a.

The bellows 18 preferably is also sealingly attached to a support ring 40 at a second end 18b of the bellows that is axially opposite the first end 18a of the bellows. For example, the valve closure element 36 may be welded to the bellows 18 generally at the location 18b. With the bellows 18 fully welded, the bellows 18 along with the support ring 40 and the valve closure element 36 sealingly encloses an optional biasing member 42, for example a spring. An upper portion 36a of the valve stem 36 is also sealingly enclosed as with the biasing member 42. The biasing member 42 may be captured between a spring guide or upper bushing 44 and a lower bushing 46, and held in compression by a threaded member 48 that may be screwed into an upper end of the valve stem 36. The lower bushing 46 is supported by a radially inward flange 50 on the support ring 40. The compressed biasing member 42 applies an upward force on the valve stem 36 so that the valve 14 in this embodiment is a normally open valve (disregarding for the moment operation of the actuator 12.) Many other designs may be used to provide the normally open functionality, and alternatively the valve 14 may be designed as a normally closed valve. Note that the biasing member 42 also causes the bellows 18 to compress longitudinally when the valve closure element 36 is moved upward (as viewed in FIG. 2.)

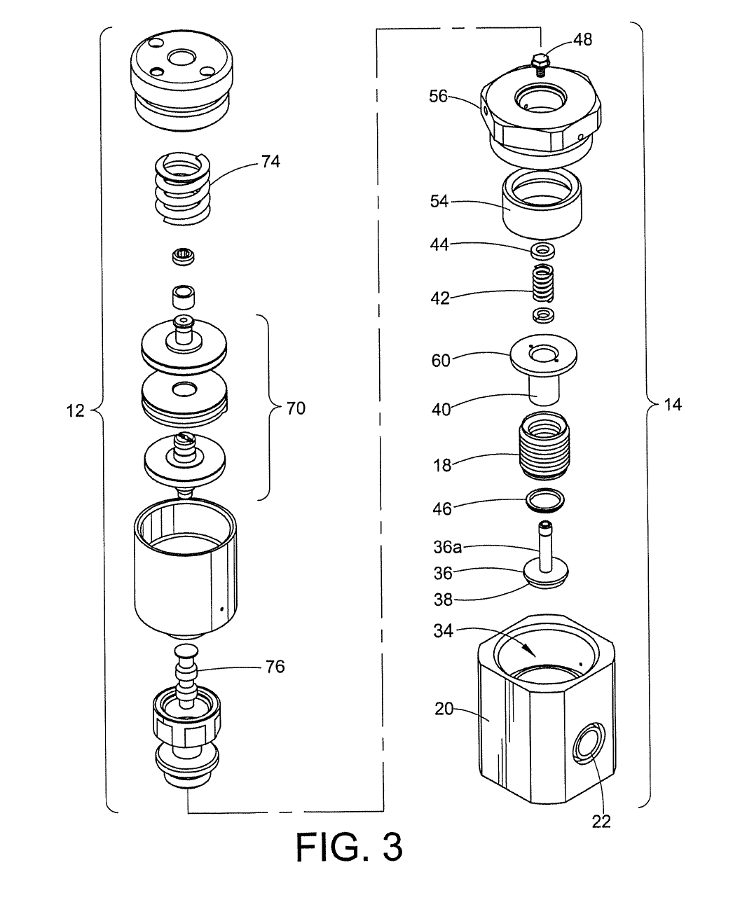

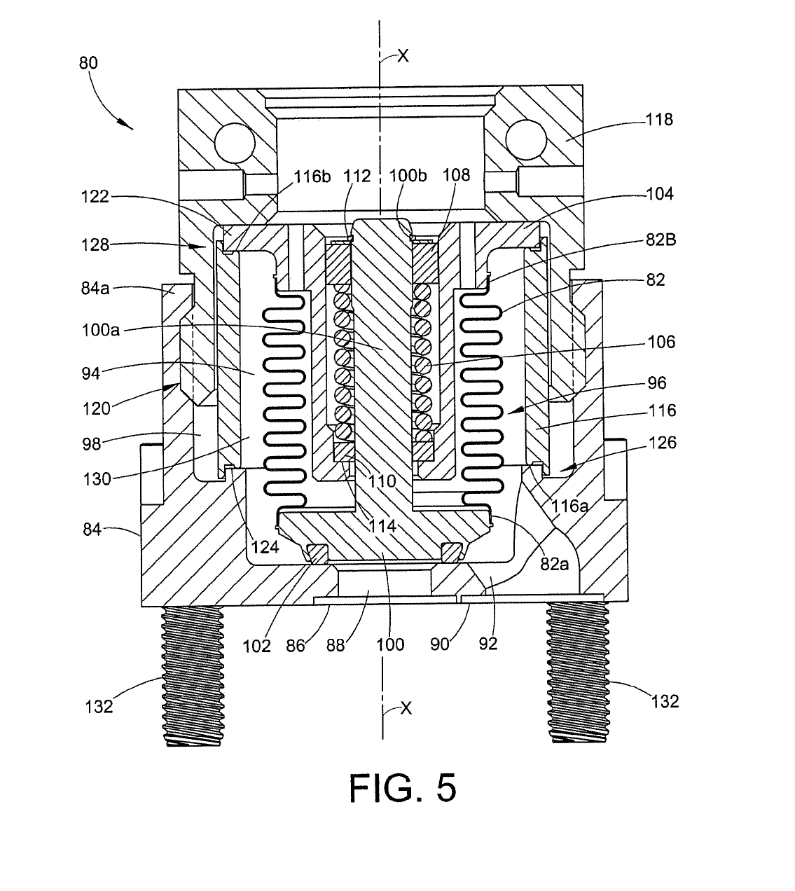

The valve body 20 may be machined or otherwise formed with a valve cavity wall 34 (valve cavity 34 for short herein) a portion of which may be cylindrical or may be generally cylindrical in shape, although alternatively other geometries may be used as needed. The valve member subassembly 32 is at least partially received in the valve cavity 34 (in the embodiment of FIG. 2 the valve member subassembly 32 is fully received in the valve cavity 34 while in the second embodiment of FIG. 5 that valve member subassembly 96 is partially received in the valve cavity.) An adapter 54 is disposed within the valve cavity 34. The adapter 54 may be shaped generally as a cylinder to be received in the valve cavity 34. Alternative geometry shapes may be used, it being preferred for convenience but not required that the adapter 54 generally conform to the shape of the valve cavity 34 (herein the adapter 54 may also be referred to as a cylinder adapter 54 for embodiments having generally cylindrical shapes for the adapter 54 and the valve cavity portion that receives the adapter.) From FIG. 3 it will be noted the generally cylindrical embodiment for the adapter 54 and the valve cavity 34. The adapter 54 thus has a smaller inside diameter than the diameter of the valve cavity 34 and a larger diameter than the bellows 18.

A bonnet nut 56 may be joined with the valve body 20 using a threaded connection 58 or other suitable means. The adapter 54 is captured and compressively axially loaded between an upper flange 60 of the support ring 40 and a support surface 62 of the valve body 20 when the bonnet nut 56 is tightened down. A fluid tight body seal 64 is made between a lower surface 54a of the cylinder adapter 54 and the support surface 62, and a fluid tight bellows seal 66 is made between an upper surface 54b of the cylinder adapter 54 and a surface 60a of the upper flange 60 of the support ring 40. To facilitate the bellows seal 66 and the body seal 64, the adapter 54 may include on the upper surface 54b an upper annular bead that forms a compression face seal with the surface 60a of the upper flange 60, and the adapter 54 may include on the lower surface 54a a lower annular bead that forms a compression face seal with the support surface 62. Therefore, after the bonnet nut 56 is tightened down onto the valve body 20, the adapter 54 in combination with the valve body 20 and the support ring 40 subdivides or partitions the valve cavity 34 to provide a sealed fluid flow cavity 68 (when the valve 14 is installed or plumbed with inlet and outlet fittings or connections attached.) The sealed fluid flow cavity 68 provides a fluid tight flow path between the first flow passageway 24 and the second flow passageway 28 when the valve 14 is in an open position and a sealed flow cavity when the valve 14 is in a closed position.

The adapter 54 in effect allows for the valve body 20 to be machined with a larger valve cavity 34 than could otherwise be provided if the adapter 54 were not used. As noted above, by larger valve cavity is meant that dimensionally either the diameter of the valve cavity can be made larger for machining the flow passageways or a shallower or shorter longitudinal length, or both if so desired. In the embodiment of FIGS. 1-3, the adapter 54 allows for a larger inside diameter of the valve cavity 34 to facilitate machining. In the second embodiment described below, an adapter may be used that provides for an axially or longitudinally shorter valve body to facilitate machining. The improved dimensioning of the valve cavity makes it easier to machine the flow passageways with shallower angles (i.e. less severe angles because deeper or sharper angles and corners in a flow path can reduce flow rate.) This allows more access room to insert a drill tool to form the angled flow passageways 24, 28. Therefore, the flow passageways 24, 28 can be formed at shallower angles (meaning the flow path through the valve is more of an in-line flow path) and with larger diameters than can be achieved if the adapter concept is not used. This is especially advantageous for valves that must meet a required space constraint.

The lower bushing 46 serves to help center the valve closure element or valve stem 36. The valve stem 36 may for example be a floating valve stem as depicted in FIG. 2, meaning that the valve stem 36 is not tied or mechanically connected to the actuator 12. Rather, the valve stem 36 upper end simply contacts a drive member (76) of the actuator (12.) The lower bushing 46 helps maintain alignment and self-centering of the valve stem 36 so as to form an effective closing seal when the valve 14 is in the closed position.

The pneumatically operated actuator assembly 16 (FIG. 2) may include a piston assembly 70 that is disposed in an actuator housing 72. The actuator 12 may be mounted to the valve 14 by a threaded connection 56a with the bonnet nut 56. As shown, the actuator housing 72 may be a multi-piece housing or alternatively a single piece housing. In the exemplary embodiment, two pistons may be used but alternatively a single piston actuator may be used or more than two pistons may be used as needed. A spring 74 biases the piston assembly 70 downward against the force of the biasing member 42. The piston assembly 70 optionally may drive a drive member 76, for example in the form of an actuator stem 76 that contacts and upper end of the valve member subassembly 32, for example, an upper surface of the threaded member 48. The spring 74 is stronger than the biasing member 42 so that with no air pressure applied to the actuator 12, the valve 14 is in a closed position and the bellows 18 is longitudinally extended. When pressurized air is supplied to the pneumatically operated actuator assembly 16, the air pressure moves the piston assembly 70 against the force of the spring 74, thereby allowing the biasing member 42 to longitudinally compress the bellows 18 to lift the valve closure element 36, thereby opening the valve 14. Alternatively, the actuator 12 may be configured so that application of pressurized air to the piston assembly 70 closes the valve 14 to provide a normally open valve. The same functionalities may alternatively be achieved with manual actuators or other actuator designs.

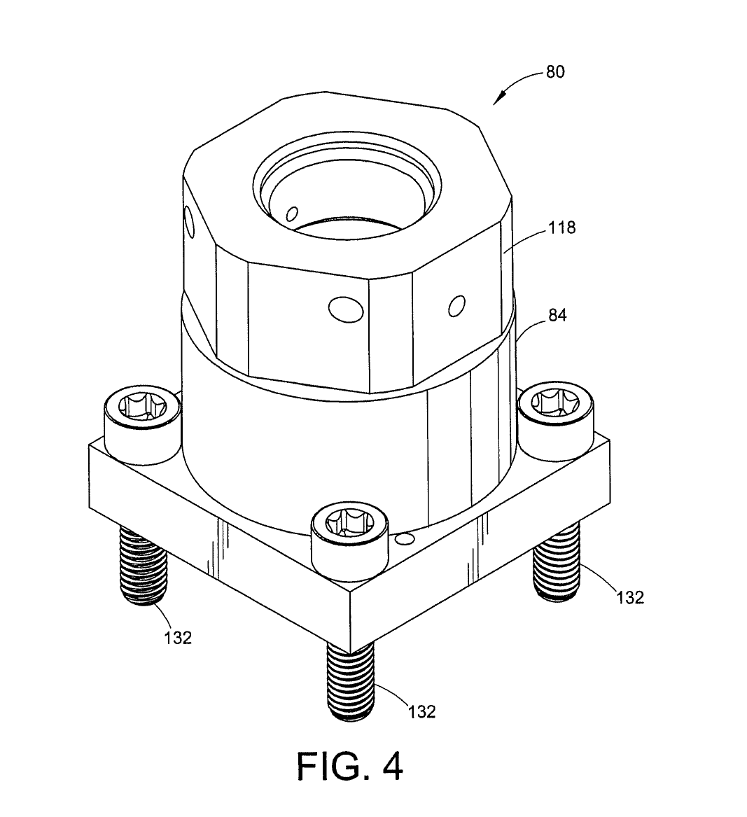

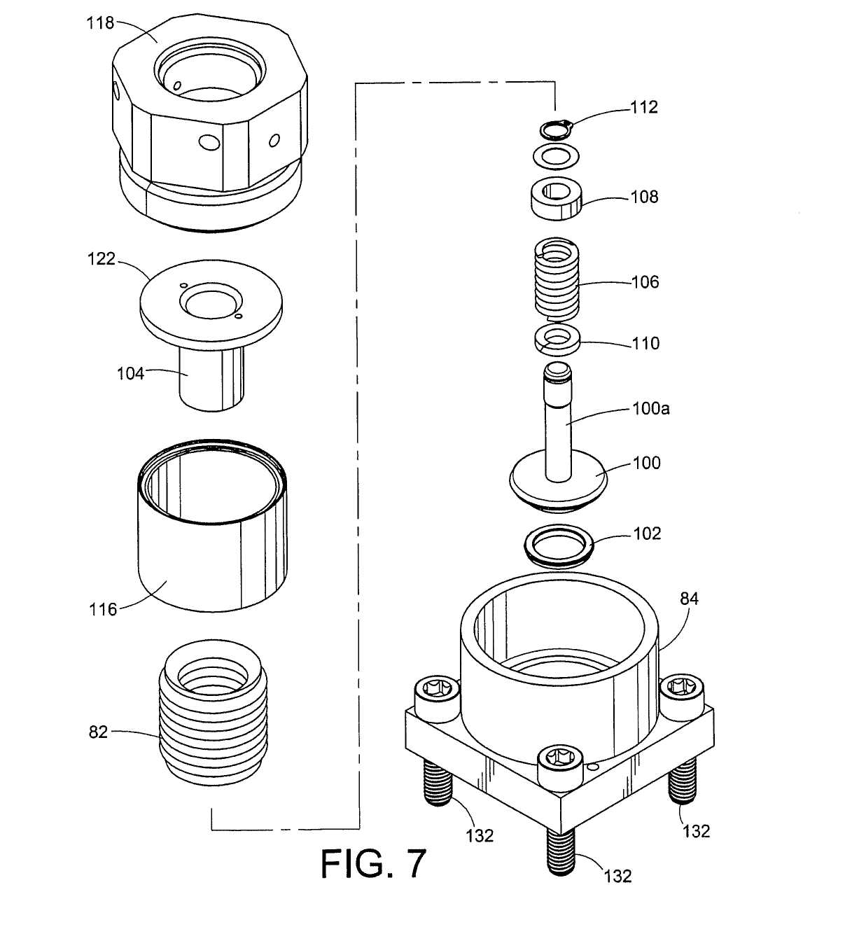

With reference to FIGS. 4-7, another embodiment of a valve 80 in accordance with the teachings herein is illustrated. FIGS. 4-7 only show the valve, not the associated actuator. An actuator as in the above embodiment may be used or a different actuator may be used as needed.

The valve 80 may have many different configurations and uses. For the exemplary embodiment illustrated herein, the valve 80 may be realized in the form of a valve that uses a hollow extensible member 82 (FIG. 5), for example a bellows, that extends and contracts axially or longitudinally to move a valve closure element (100) to open and close the valve 80 in response to operation of an actuator. Although the exemplary embodiments herein are described in the context of a bellows valve, we intend the terms “hollow extensible member” and “bellows” to be construed broadly, and to include a conventional or traditional bellows design or alternative bellows designs, for example a series of conical elements or springs or other elements that form a hollow extensible member, or designs that function similarly but are not necessarily understood to be a bellows in the conventional sense. Bellows valves find particular use for high purity, high flow rate applications, but the inventions may be used in valves for many other types of applications.

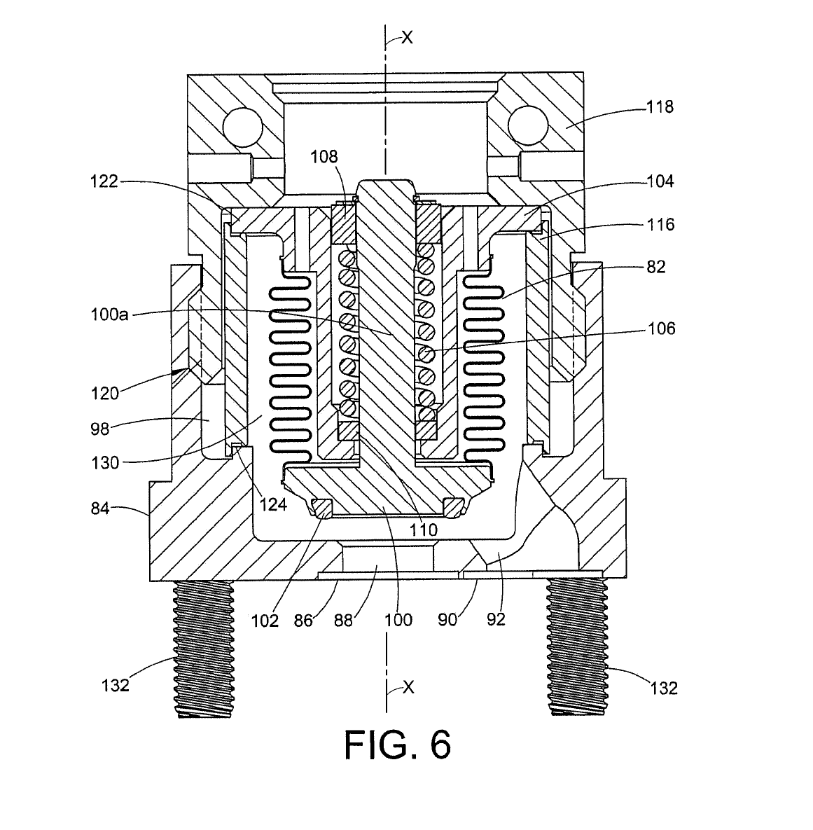

An embodiment of a bellows valve in accordance with the teachings herein includes a valve body 84 that has two or more flow passageways therein so as to control the flow of fluid, for example a liquid or gas, from one port to another. For example, in a two port embodiment, a first or inlet flow port 86 opens to a first or inlet flow passageway 88. A second or outlet flow port 90 opens to a second or outlet flow passageway 92. A sealed fluid flow cavity 94 opens to the outlet flow passageway 92 when the valve 80 is in an open position (note that FIG. 5 shows a valve closed position and FIG. 6 shows a valve open position). The inlet flow passageway 88 opens to the sealed fluid flow cavity 94. The designations of inlet and outlet are arbitrary, it being understood that flow can be reversed through the valve 80 if so desired, and flow can be directed to other ports in a multi-port embodiment (not shown) if so need. The fluid flow cavity 94 is sealed in the sense that fluid is contained when the valve 80 is closed and fluid flows between the first flow passageway 88 and the second flow passageway 92 when the valve 80 is open.

A valve member subassembly 96 may be at least partially disposed in a valve cavity 98 that optionally may be formed in a generally cylindrical shape in the valve body 84. The valve member subassembly 96 may include a valve closure element 100, for example, a valve stem. The valve stem 100 optionally carries or supports a valve seat 102. Alternatively, the valve seat 102 may be disposed in a groove in the valve body 84. The valve closure element 100 preferably is sealingly attached to a first end 82a of the bellows 82. For example, the valve closure element 100 may be welded to the bellows 82 generally at the location indicated at 82a.

The bellows 82 preferably is also sealingly attached to a support ring 104 at a second end 82b of the bellows that is axially opposite the first end 82a of the bellows. For example, the valve closure element 100 may be welded to the bellows 82 generally at the location indicated at 82b. With the bellows 82 fully welded, the bellows 82 along with the support ring 104 and the valve closure element 100 sealingly encloses an optional biasing member 106, for example a spring. An upper portion 100a of the valve stem 100 is also sealingly enclosed as with the biasing member 106. The biasing member 106 may be captured between a spring guide or upper bushing 108 and a lower bushing 110, and held in compression by a retainer 112, for example a snap ring or other suitable retainer, that is received in a recess 100b in the valve stem 100. The lower bushing 110 is supported by a radially inward flange 114 on the support ring 104. The compressed biasing member 106 applies an upward force on the valve stem 100 so that the valve 80 in this embodiment is a normally open valve (disregarding for the moment the operation of an actuator.) Many other designs may be used to provide the normally open functionality, and alternatively the valve 80 may be designed as a normally closed valve. Note that the biasing member 106 also causes the bellows 82 to compress longitudinally when the valve closure element 100 is moved upward (see FIG. 6.)

The valve body 84 may be machined or otherwise formed with the valve cavity wall 98 (valve cavity 98 for short herein) a portion of which may be cylindrical or may be generally cylindrical in shape, although alternatively other geometries may be used as needed. The valve member subassembly 96 is at least partially received in the valve cavity 98 (in the embodiment of FIG. 2 the valve member subassembly 32 is fully received in the valve cavity 98 while in the second embodiment of FIG. 5 that valve member subassembly 96 is partially received in the valve cavity 98.) An adapter 116 is disposed within the valve cavity 98 thereby having a smaller inside diameter than the diameter of the valve cavity 98 and larger than the diameter of the bellows 82. As in the first embodiment above, the valve cavity 98 may have a cylindrical portion that receives the adapter 116 that may also be in the general shape of a cylinder (as in the first embodiment the adapter 116 may be referred to herein as a cylinder adapter for the described embodiment.)

A bonnet nut 118 may be joined with the valve body 84 using a threaded connection 120 or other suitable means. The adapter 116 is captured and compressively axially loaded between an upper flange 122 of the support ring 104 and a support surface 124 of the valve body 84 when the bonnet nut 118 is tightened down. A fluid tight body seal 126 is made between a lower surface 116a of the adapter 116 and the support surface 124, and a fluid tight bellows seal 128 is made between an upper surface 116b of the adapter 116 and a surface 122a of the upper flange 122 of the support ring 104. To facilitate the bellows seal 128 and the body seal 126, the adapter 116 may include on the upper surface 116b an upper annular bead that forms a compression face seal with the surface 122a of the upper flange 122, and the adapter 54 may include on the lower surface 116a a lower annular bead that forms a compression face seal with the support surface 124. Therefore, after the bonnet nut 118 is tightened down onto the valve body 84, the adapter 116 in combination with the valve body 84 and the support ring 104 subdivides or partitions the valve cavity 98 to provide a sealed fluid flow cavity 130 (when the valve 80 is installed or plumbed with inlet and outlet fittings or connections attached.) The sealed fluid flow cavity 130 provides a fluid tight flow path between the first flow passageway 88 and the second flow passageway 92 when the valve 80 is in an open position and a sealed flow cavity when the valve 80 is in a closed position.

The adapter 116 in effect allows for the valve body 84 to be machined with a shallower valve cavity 98 than could otherwise be provided if the adapter 116 were not used. The valve body 84 may include an upper wall 84a which may be longitudinally shorter than in a traditional valve because the adapter 116 effectively serves as a valve body extension. By longitudinally shorter is meant that the upper wall 84a extends or terminates axially from the flow passageways 88, 92 by a lesser distance as compared to a traditional valve body.) As viewed in FIG. 5, for example, the adapter 116 upper end may extend axially in effect to the length of the valve body wall 84a that would be needed to accommodate the length of the bellows 82 if the adapter 116 were not used. In other words, the adapter 116 has a distal upper end that extends axially past a distal upper end of the valve body 84 that joins with an actuator. For example, when installed, the distal end of the adapter 116 is axially further from the flow passageways 88, 92 than the distal end of the valve body 84. This allows the flow passageways 88 and 92 to be machined more easily before the adapter 116 is installed, thereby facilitating the machining operation because the shorter valve body allows the machine tool easier access into the valve cavity. The shorter valve body allows more access room to insert a drill tool to form the angled flow passageways 92. Thus, for both embodiments of FIGS. 2 and 5 the separate adapter (54, 116) facilitates valve body machining operations by effectively opening up access into the valve cavity to form the angle flow passageways as previously described hereinabove.

As in the first embodiment, the lower bushing 110 serves to help center the valve closure element or valve stem 100. In both embodiments, a lower bushing and floating valve stem design are optional. Also note that the first and second ports 86, 90 in the second embodiment are located in a common lower surface of the valve body 84. As such, this configuration is what is generally and commonly known as a surface mount configuration. However, other porting configurations may be used, for example as shown in the first embodiment herein. Mounting bolts 132 may be used to attach a surface mount fluid component to an underlying substrate or manifold as is known.

Note that an additional benefit of the adapter concept is that the adapter in effect decouples the valve body from the bellows. In other words, the bellows and the adapter preferably are not welded to each other nor to the valve body. The use of a compression seal or other mechanical seal means (mechanical as distinguished from a welded connection) between the adapter and the valve body as well as between the adapter and the valve member subassembly allows for easy installation of the valve member subassembly into the valve body, and also the adapter and the valve member subassembly to be removed easily and replaced if so needed for maintenance or repair. Alternatively, the adapter may be welded at one end to the valve member subassembly to form a single piece component and then installed with a single compression seal for the body seal. In either scenario, different adapters having different dimensions such as diameter or longitudinal length may be used to accommodate different bellows designs while still fitting into a particular or common valve body. This means that a single valve body size may be used with different bellows sizes by use with an appropriately sized adapter. Moreover, a particular bellows design may be used in differently sized valve bodies by providing different adapters as needed.

The inventive aspects and concepts have been described with reference to the exemplary embodiments. Modification and alterations will occur to others upon a reading and understanding of this specification. It is intended to include all such modifications and alterations insofar as they come within the scope of the appended claims or the equivalents thereof.

1. A valve, comprising:
a valve body, said valve body comprising a valve cavity, a first flow passageway that extends from said valve cavity to a first fluid port, a second flow passageway that extends from said valve cavity to a second fluid port,
a valve member subassembly disposed at least partially within said valve cavity, said valve member subassembly comprising a hollow extensible member having a first end that is attached to a valve closure element and a second end that is attached to a support ring,
an adapter having a first end that seals against said support ring and a second end that seals against said valve body to provide a sealed cavity that provides a fluid flow path between said first flow passageway and said second flow passageway when the valve is in an open position.

2. The valve of claim 1 wherein said hollow extensible member comprises a bellows.

3. The valve of claim 2 wherein said bellows is attached at said first end by a weld to said valve closure element and is attached at said second end by a weld to said support ring.

4. The valve of claim 1 wherein said valve closure element comprises a valve seat.

5. The valve of claim 1 in combination with a valve actuator.

6. The valve of claim 5 wherein said valve actuator comprises a pneumatic actuator, a hydraulic actuator, a manual actuator or an electro-magnetic actuator.

7. The valve of claim 1 wherein said first fluid port and said second fluid port open through a common surface of said valve body to form a surface mount valve.

9. The valve of claim 1 wherein said first fluid port and said second fluid port open through a different respective surfaces of said valve body to form an in-line valve or a multi-port valve.

10. The valve of claim 1 wherein said adapter comprises a cylindrical adapter that is disposed between a cylindrical portion of a said valve cavity and said hollow extensible member.

11. A valve, comprising:
a valve body comprising a valve cavity for fluid flow through the valve between an inlet and an outlet,
a valve member comprising a hollow extensible member disposed in said valve cavity, said hollow extensible member having a diameter that is less than a diameter of said valve cavity,
an adapter having a diameter that is greater than said hollow extensible member diameter and less than said valve cavity diameter.

12. The valve of claim 11 wherein said adapter comprises a first axial end that forms a compression seal with a surface of said valve body.

13. The valve of claim 12 wherein said adapter comprises a second axial end that is opposite said first axial end and forms a compression seal with said valve member.

14. The valve of claim 11 wherein said valve member comprises bellows.

15. The valve of claim 11 in combination with a valve actuator.

16. The valve of claim 15 wherein said valve actuator comprises a pneumatic actuator, a hydraulic actuator, a manual actuator or an electro-magnetic actuator.

17. A valve, comprising:
a valve body comprising a valve cavity for fluid flow through the valve between a first flow passageway and a second flow passageway,
a valve member comprising a hollow extensible member disposed in said valve cavity, said hollow extensible member having a diameter that is less than a diameter of said valve cavity,
an adapter having a diameter that is greater than hollow extensible member diameter and less than said valve cavity diameter,
said adapter having a distal end that is axially further from said first flow passageway and said second flow passageway than a distal end of said valve body.

18. The valve of claim 17 wherein said hollow extensible member comprises a bellows.

19. The valve of claim 17 in combination with a valve actuator.

20. The valve of claim 19 wherein said valve actuator comprises a pneumatic actuator, a hydraulic actuator, a manual actuator or an electro-magnetic actuator.
